(19) United States
(12) Patent Application Publication
(10) Pub. No.: US 2015/0213633 A1
(43) Pub. Date: Jul. 30, 2015

(54) SYSTEM, METHOD AND COMPUTER-ACCESSIBLE MEDIUM FOR PROVIDING A PANORAMIC CONE BEAM COMPUTED TOMOGRAPHY (CBCT)

(71) Applicants: Jenghwa Chang, New York, NY (US); K.S. Clifford Chao, New York, NY (US); Lili Zhou, Stony Brook, NY (US)

(72) Inventors: Jenghwa Chang, New York, NY (US); K.S. Clifford Chao, New York, NY (US); Lili Zhou, Stony Brook, NY (US)

(73) Assignee: The Trustees of Columbia University in the City of New York, New York, NY (US)

(21) Appl. No.: 14/110,282

(22) PCT Filed: Apr. 6, 2012
(86) PCT No.: PCT/US12/32574

§ 371 Date: Mar. 18, 2015

Related U.S. Application Data
(60) Provisional application No. 61/618,270, filed on Mar. 30, 2012.
(60) Provisional application No. 61/472,434, filed on Apr. 6, 2011.

(51) Int. Cl. G06T 11/60; G06T 11/00

(52) U.S. Cl. CPC G06T 11/60; G06T 11/008; G06T 2207/10081

(57) ABSTRACT

Exemplary devices, procedures and computer-readable mediums for providing a projection image associated with at least one target. The projection image can be formed from a plurality of locations of a source arrangement. At each source location, a plurality of panoramic projection images associated with a target can be acquired. At least two of the panoramic projection images can be obtained at view angles which are different from one another. These panoramic projection images can be stitched together or otherwise combined. A resulting image can then be generated using a computed tomography procedure based on the stitched or combined projection images that are generated at the plurality of location.

### CROSS-REFERENCE TO RELATED APPLICATIONS

This application relates to and claims priority from U.S. Patent Application Ser. Nos. 61/472,434, filed on Apr. 6, 2011, and 61/618,270, filed on Mar. 30, 2012, the entire disclosures of which are hereby incorporated herein by reference.

### FIELD OF THE DISCLOSURE

The present disclosure generally relates to medical imaging, and in particular to exemplary embodiments of apparatus, methods, and computer-accessible medium for panoramic cone-beam computed tomography.

### BACKGROUND INFORMATION

Image guided radiotherapy (IGRT) can include a radiotherapy procedure that uses imaging devices to guide treatment setup and dose delivery. Among many imaging/tracking devices used for IGRT, linear accelerator (linac) based cone-beam computed tomography (CBCT) is one of the most powerful tools for therapy guidance. CBCT has been used as a three-dimensional (3D) imaging method in IGRT to provide volumetric information for real-time patient setup, dose verification and treatment planning, among others.

However, there may be many drawbacks in the current implementation of CBCT. One problem is the small imaging volume (e.g., due to small imager size) compromising the accuracy of target delineation. For example, the maximum size of a commercial amorphous silicon detector can be 40 cm in width (or in the transverse direction). If an imaging panel of this size is positioned, e.g., 150 cm from the source for full-fan CBCT acquisition (e.g., the central axis of the linac aligned with the center of the imaging panel), a half-scan gantry rotation corresponding to 180°+θ_{cone} where θ_{cone} is the cone angle, can be needed to get a complete data set for CBCT reconstruction with an imaging volume of, e.g., 26.7 cm in diameter.

This imaging volume of full-fan, half-scan CBCT acquisition may not be large enough to encompass the full patient anatomy for almost all treatment sites, making it difficult to identify the treatment target and surrounding critical organs for image-guided setup. A “truncated” imaging volume can also lead to incorrect CT numbers and reconstruction artifacts because the attenuation outside the imaging volume can be back-projected into the imaging volume. De-truncation algorithms have been developed to extrapolate/approximate the measurements outside the imaging panel and therefore extend the imaging volume. However, the CT numbers obtained from these methods are approximate and truncation artifacts/distortions exist in reconstructed images.

The imaging volume can also be increased by shifting the imaging panel laterally, e.g., up to 50 percent, which can be referred to as the shifted/displaced detector scan (e.g., in micro-CT literatures), or half-fan acquisition (e.g., in IGRT literatures). This approach can theoretically double the imaging volume (e.g., to 53.4 cm in diameter). Although this imaging volume may still not be large enough to cover the whole patient anatomy for most thoracic, abdominal and pelvic cases, the associated problems (incorrect CT numbers and artifacts) can be not as severe as those for the full-fan, half-scan acquisition. As a result, the half-fan acquisition has been successfully used for the majority of IGRT cases. However, half-fan CBCT can require full-scan (360°) gantry rotation, which is not always possible.

FIG. 1 illustrates a front view of a linac 100 with an on-board kV imaging system (consisting of a source 110 and an imaging panel 115) attached to the gantry using robotic arms (e.g., 120). FIG. 1 also shows exemplary distances between the isocenter 130 and the linac head 125, kV imaging panel 115 and kV source 110. As shown in FIG. 1, among the linac head 125, kV imager 115 and kV source 110, the linac gantry head 125 can be closest to the isocenter and might cause a collision during a 360° gantry rotation, particularly if the couch 135 is shifted laterally or inferiorly for peripheral lesions. Therefore, in order to avoid collisions, most patients with peripheral lesions can be limited to being imaged at the central location instead of the real treatment position for CBCT acquisition. Moving the patient back and forth between the treatment and imaging positions can be uncomfortable for the patients, can prolong the treatment time, and can introduce additional uncertainties (e.g., patient motions) that may need to be monitored. Moreover, this additional shift might compromise the accuracy of image guidance because the effect of an error in measuring rotation is amplified as the point of interest (e.g., treatment iso-center) gets farther from the axis of rotation (imaging iso-center).

Data redundancy can cause artifacts for half-scan CT/CBCT reconstruction using FBP-type procedures as some line integrals can be back-projected twice while most are considered only once. Previous studies show that half-scan CT/CBCT reconstruction using modified weighting for FBP-type algorithms can equalize the uneven contributions for different line integrals and provide comparable image quality as the full-scan CT/CBCT reconstruction. CBCT reconstructions using the FDK algorithm can also be prone to inherent shading artifacts (also referred to as cone-beam artifacts), particularly for half-scan acquisition because the cone beam projection images acquired in a circular trajectory might not completely cover the Fourier space and thus, might not provide complete data.

Another exemplary method for CT/CBCT reconstruction can be a simultaneous algebraic reconstruction technique (SART)—an algebraic reconstruction method solving the linear system using iterative methods without direct matrix inversion. In comparison to the FBP approach, the algebraic method can be generally more advantageous in CT and CBCT reconstruction using incomplete data because the algebraic method is easy to implement for different scanning geometries. In addition, it can be flexible in incorporating a priori information about the imaging volume, is more economic in extracting tomographic information from the projection images, and does not require data weighting. For example, Mueller (see K. Mueller, Fast and accurate three-dimensional reconstruction from cone-beam projection data using algebraic methods. (The Ohio State University, 1998)) demonstrated that less projections are required for the SART than for the FDK reconstruction for the same image quality. H. Guan and R. Gordon, “Computed tomography using algebraic reconstruction techniques (ARTs) with different projection access schemes: a comparison study under practical situations,” Physics in Medicine and Biology 41, 1727 (1996), on the other hand, showed that for the same limited number of projections, the algebraic formulation can produce better reconstructions than the FBP method. W. Ge, G. Schweiger and M. W. Vannier, “An iterative algorithm for X-ray CT fluoroscopy,” Medical Imaging, IEEE Transactions on 17, 853-856 (1998), demonstrated that metal artifacts can be more successfully reduced with iterative reconstruction methods. C. Maaβ, F. Dennerlein, F. Noo and M. Kachelrieβ, presented at the Nuclear Science Symposium Conference Record (NSS/MIC), 2010 IEEE, 2010 (unpublished) compared different CBCT reconstruction procedures, and concluded that the SART showed significantly reduced cone-beam artifacts in comparison to the FDK algorithm. Finally, the study by F. Noo, C. Bernard, F. X. Litt and P. Marchot, “A comparison between filtered backprojection algorithm and direct algebraic method in fan beam CT,” Signal Processing 51, 191-199 (1996) demonstrated that variable detector sizes inside projections can be handled with SART provided that the detector geometry remains unchanged from one projection to another.

A potential source of reconstruction artifacts for panoramic CBCT is imperfect image stitching due to uncertainties in imaging position or output fluctuation. Many commercially available electronic portal imaging device (EPID) systems can be attached to the linac using robotic arms, from which the location of the imaging panel can be read. M. W. D. Grattan and C. K. McGarry, “Mechanical characterization of the Varian Exact-arm and R-arm support systems for eight aS500 electronic portal imaging devices,” Medical Physics 37, 1707-1713 (2010) investigated the mechanical characterization of the robotic arms for commercial EPID systems and reported that the digital readout and the exact imaging position might differ by a few millimeters due to gantry sag. The exposure level of an x-ray imaging system can fluctuate on the order of a few percents each time the beam is turned on for the same mAs setting. This fluctuation may cause artifacts and incorrect CT numbers in the reconstructed images because the backprojection of the projection images for each view angle can be unevenly distributed and concentrated in certain regions within the imaging volume.

Thus, there is a need to address and/or overcome at least some of the above-described deficiencies.

### SUMMARY OF EXEMPLARY EMBODIMENTS

To address at least some of these drawbacks, exemplary embodiments of system, method and computer-accessible medium can be provided which can utilize and exemplary “panoramic CBCT” technique that can image patients at the treatment position with an imaging volume as large as practically needed. As shown in FIG. 1, a collision may not occur for a half-scan rotation (e.g., 180°+θ_{cone}) if the gantry head 125 rotates on the “far” side of the couch 135. According to certain exemplary embodiments of the present disclosure, it is possible to provide an imaging panel which can be large enough to encompass the whole anatomy for a full-fan, half-scan CBCT acquisition so that the linac head 125 does not have to rotate to the “near” side of the couch. Since an imaging panel of this size may not exist, according to one exemplary embodiment of the present disclosure, it is possible to split the view of the this large imaging panel into smaller ones that can be imaged with the existing imaging panel, and rotate the gantry multiple times, one half-scan rotation for each view. The exemplary projection images from multiple views can then be stitched together and reconstructed using standard reconstruction algorithms for full-fan, half-scan CBCT. The name “panoramic CBCT” can be selected for this CBCT technique due to its similarity to the panoramic photography.

The exemplary stitched projection images can be reconstructed, e.g., using the exemplary system, method and/or computer-accessible medium, using the standard FDK (Feldkamp, Davis and Kress) algorithm (see, e.g., L. A. Feldkamp, L. C. Davis and J. W. Kress, “Practical cone-beam algorithm,” J. Opt. Soc. Am. A 1, 612-619 (1984)), e.g., a type of Filtered Backprojection (FBP) algorithm developed for CBCT reconstruction. As indicated further herein, providing an exemplary scanning geometry for acquiring projection images for multiple panoramic views can be beneficial. Indeed, the use of an exemplary direct imaging stitching system, method and computer-accessible medium can be used, and a modified SART can also be utilized for a panoramic CBCT reconstruction. CBCT reconstructions from simulated panoramic projection images of digital phantoms can be presented and the image quality can be compared. Reconstruction artifacts can be studied for simulated imperfect stitching including gaps, columns missing/repeating at intersection, and exposure fluctuation between adjacent views. Exemplary results from the Monte Carlo simulations of projection images for standard and panoramic CBCT be used to review and determine the effects of scattering on image quality and imaging dose. Further, potential applications of this imaging technique for clinical use are discussed herein.

Exemplary “panoramic CBCT” according to certain exemplary embodiments of the present disclosure can image targets (e.g., portions of patients) at the treatment position with an imaging volume as large as practically needed. Using the exemplary “panoramic CBCT” techniques, the target can be scanned sequentially from multiple view angles. For each view angle, a half scan can be performed with the imaging panel positioned in any location along the beam path. The panoramic projection images of all views for the same gantry angle can then be stitched together with the direct image stitching method and full-fan, half-scan CBCT reconstruction can be performed using the stitched projection images. Accordingly, the exemplary embodiments of the panoramic CBCT technique, system, method and computer-accessible medium can be provided which can image tumors of any location for patients of any size at the treatment position with comparable or less imaging dose and time.

According to certain exemplary embodiments of the present disclosure, systems, methods and computer-accessible mediums can be provided for panoramic cone beam computed tomography (CBCT). For example, for a plurality of source locations, it is possible to acquire a plurality of panoramic projection images, at least two of which have different associated view angles; stitching the panoramic projection images together to form a larger projection image, In addition, an exemplary CBCT reconstruction can be performed using the stitched projection images.

Further, the exemplary acquisition of panoramic projection images can include scanning a target with a source aiming at multiple view angles with a field size comparable to the size of an imager; and/or repositioning the imager according to the multiple view angles. Further, the exemplary aiming the source at multiple view angles can include either physically rotating the source or using different collimator settings. The exemplary imager can be positioned in any location along a beam path. The exemplary stitching of the panoramic projection images can include, for each view angle, interpolating projection images of neighboring gantry angles to produce projection images at the designated gantry angles; direct stitching of the projection images of the same gantry angle according to the imager position reported by the controller; and software stitching to combine projection images of the same gantry angle together using features identified by the image processing software.

In addition, the exemplary CBCT reconstruction can be performed using at least one of: standard CBCT reconstruction by projecting the stitched projection image into one plane perpendicular to the central axis of the source; and special reconstruction procedures that reconstruct tomographic images from the stitched projection images without additional projection to a plane perpendicular to the central axis. The exemplary CBCT reconstruction can include a reconstruction volume proportional to the number of panoramic views; and can be achieved with exemplary projection images obtained from a half gantry rotation. Further, in certain exemplary embodiments, the half gantry rotation can be one half of a quantity: 180 degrees plus a cone angle.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a front view of a linear accelerator (linac) which can be used with exemplary embodiments of system, method and computer-accessible medium of the present disclosure;

FIGS. 2A-2B are exemplary illustrations of exemplary exemplary implementations of panoramic CBCT, according to certain exemplary embodiments of the present disclosure;

FIGS. 3A-3D are exemplary illustrations of scenarios between two adjacent views;

FIGS. 4A-4E are exemplary views of an exemplary MCAT phantom, according to certain exemplary embodiments of the present disclosure;

FIG. 5 is a set of exemplary images comparing slices for CBCT reconstructions, according to certain exemplary embodiments of the present disclosure;

FIGS. 6A-6D is an exemplary profile image and comparison graphs for the central profiles of the transverse view between the MCAT phantom and the exemplary reconstructed images, according to certain exemplary embodiments of the present disclosure;

FIG. 7 is an illustration of exemplary difference images between ane exemplary large panel/full scan and an exemplary large panel/half scan, and further between an exemplary large panel/full scan and three exemplary panoramic views/half scan, according to certain exemplary embodiments of the present disclosure;

FIG. 8 is a set of exemplary image reconstructions using the exemplary projection images of the central view, according to certain exemplary embodiments of the present disclosure;

FIG. 9 is a set of images illustrating reconstruction artifacts due to imperfect stitching simulated by introducing gaps between adjacent views, according to certain certain exemplary embodiments of the present disclosure;

FIG. 10 is a set of exemplary images illustrating projection images with three consecutive columns of pixels removed at the intersection between two adjacent views, according to certain exemplary embodiments of the present disclosure;

FIG. 11 is a set of exemplary images illustrating projection images with three consecutive columns of pixels removed at the intersection between two adjacent views, according to certain exemplary embodiments of the present disclosure;

FIG. 12 is set of exemplary images illustrating projection images with the image intensity of the left and right views increases by 5% and 3%, respectively, according to certain exemplary embodiments of the present disclosure;

FIG. 13 is a set of exemplary views of a simulated lung tumor, according to certain exemplary embodiments of the present disclosure;

FIG. 14 is a set of exemplary simulated projection images and descriptive graphs, according to certain exemplary embodiments of the present disclosure;

FIG. 15 is a set of exemplary images of CBCT reconstructions of the MCAT phantom using the exemplary projection images, according to certain exemplary embodiments of the present disclosure;

FIG. 16 is an exemplary system, including an exemplary computer-accessible medium, according to one or more exemplary embodiments of the present disclosure; and

FIG. 17 is a flow diagram showing an exemplary procedure, according to certain exemplary embodiments of the present disclosure.

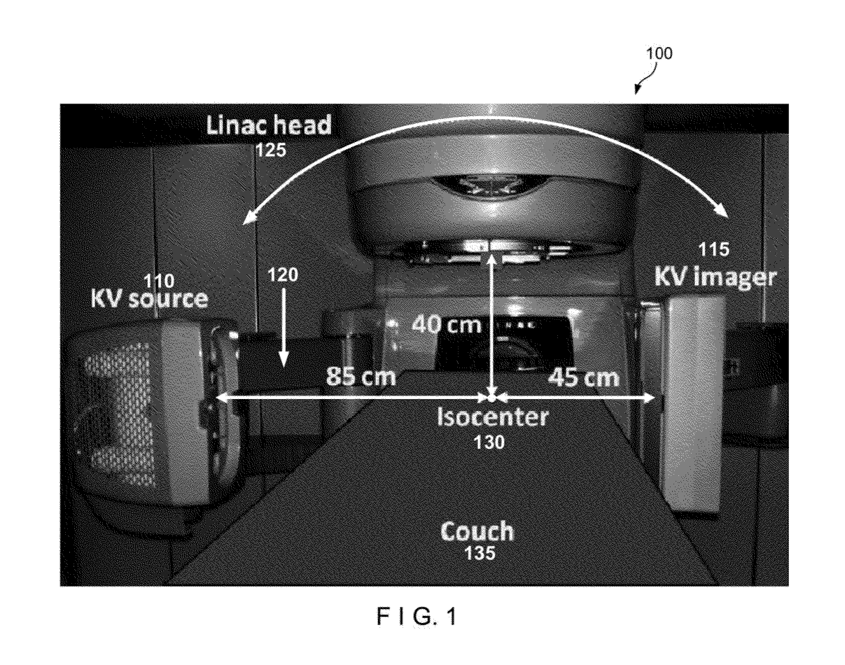

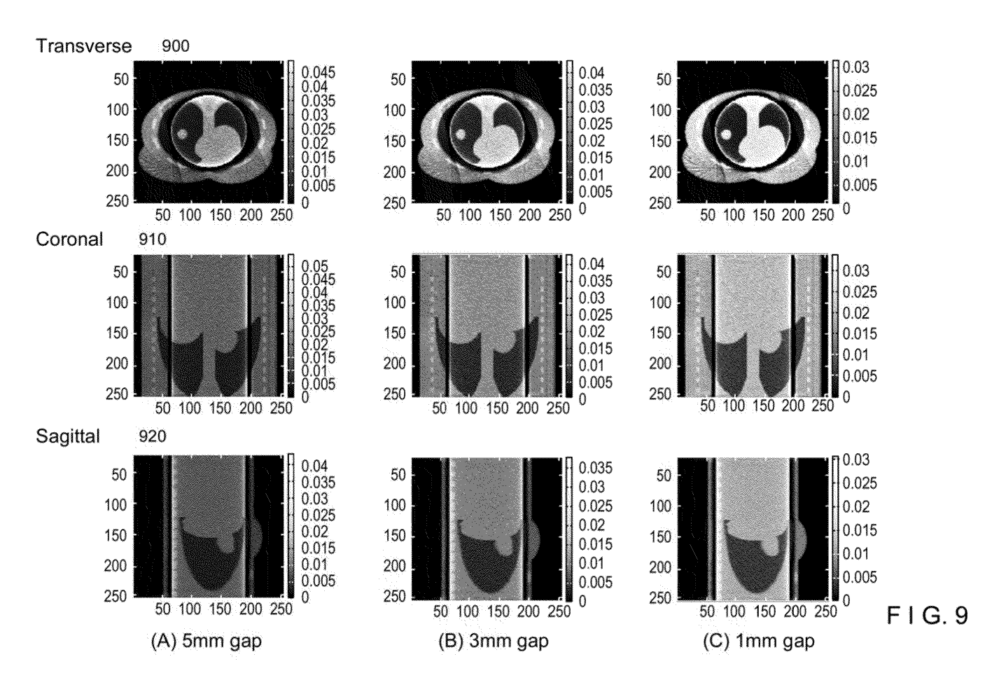

Throughout the drawings, the same reference numerals and characters, unless otherwise stated, are used to denote like features, elements, components, or portions of the illustrated embodiments. Throughout the drawings, lettered elements (e.g., “A”) of a Figure, (e.g., “FIG. 1”) may be referred to as “FIG. 1, element A,” “FIG. 1A,” or similar, unless otherwise stated. Further, Figures can include multiple elements having a letter designation (e.g., “A”) and reference to that letter can denote all elements marked with the letter within the Figure, unless otherwise stated. Further, certain markings can apply to multiple elements within a row or column, such as FIG. 9, where the bottom left image can be referred to as 920A and the center image 910B, etc. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

### Exemplary Implementation of “Panoramic CBCT”

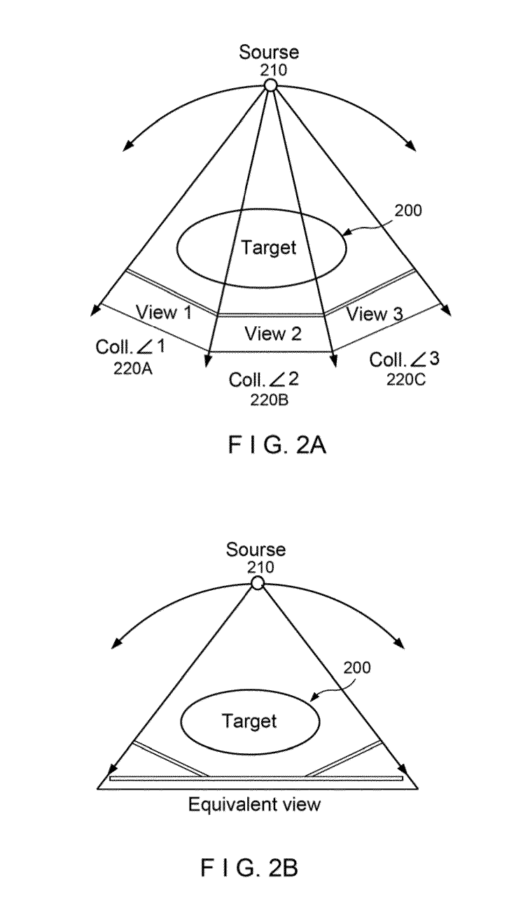

As shown in FIG. 2A, for “panoramic CBCT,” a target 200 can be scanned panoramically with the source aiming at multiple view angles with a field size comparable to the size of the imaging panel, stitch together the projection images of all views for the same gantry position to form a larger projection image, and perform CBCT reconstruction using the stitched projection images. Aiming the source at multiple view angles can be achieved by either rotating the source 210 physically or using different collimator settings 220A-C, e.g., as shown in FIG. 2A. For each view angle, the imaging panel can be positioned in any location along the beam path.

Since the CBCT volume can be proportional to the size of the projection data, the panoramic CBCT technique can theoretically increase the imaging volume to as large as practically needed. For many patients, 2-3 view angles should be sufficient to cover the whole anatomy with the commercially available EPIDs. Unlike the half-fan, full-scan CBCT scan, the panoramic CBCT can obtain complete reconstruction of any patient size using the half scan (180°+θ_{cone}) without having to shift the patient to the central location to avoid collisions. The panoramic CBCT also addresses the issues on reconstruction artifacts and incorrect CT numbers due to truncation.

Since the multiple panoramic views are not necessarily on the same plane, the stitched view may not be directly inputted into the standard FDK 22 or SART 36 reconstruction programs coded for cone beam geometry. Instead, as shown in FIG. 1B, it is possible to project and re-bin the stitched projection images onto an “equivalent imaging panel” normal to the central axis by ray tracing and interpolation, considering the beam divergence to produce “equivalent projection images” for full-fan, half-scan CBCT reconstruction. Alternatively, exemplary procedures can be used to reconstruct the CBCT directly from the stitched projection images without additional projection and re-binning.

### Exemplary Image Stitching

Image stitching can be a pre-processing of the projection data to select and group the detector readings from all panoramic views for CBCT reconstruction. Although it is not required for all CBCT reconstruction procedures, the image stitching illustrated in FIG. 2 can be performed using exemplary embodiments of the present disclosure to pre-process the projection data suitable enough so that the same data-set could be used to test the FBP and algebraic reconstruction procedures, and the reconstruction results can be fairly compared. Stitching of the exemplary panoramic projection images can be achieved by direct image stitching, e.g., combination of the projection images of the same gantry angle according to the imaging position reported by the controller of the robotic arms. Alternatively, image processing procedures can be developed to stitch projection images based on the identified common features on adjacent views. If the projection images are not acquired at exactly the same gantry angles, interpolation of projection images of neighboring gantry angles can be used to produce the exemplary projection images at the desired gantry angles.

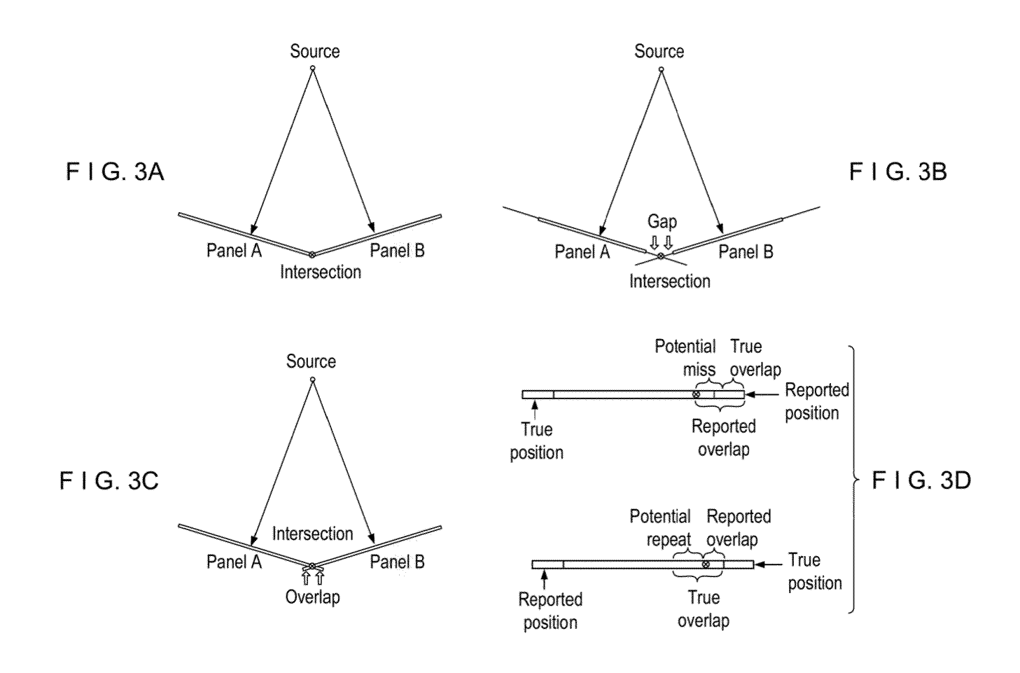

In the exemplary embodiments described herein, direct image stitching based on the location of the imaging panel is described to, e.g., stitch the projection images from multiple views, although other procedures can be used. The exemplary imaging panel for each view can be mathematically defined as a rectangle with the specified size (e.g., width×length where width is the size in the transverse direction and length in the longitudinal direction). For exemplary direct image stitching, it can be possible to first identify the intersection between two adjacent views by extending the rectangles of both imaging panels until they intersected. As shown in FIGS. 3A-3D, depending on the location of the intersection, it is possible to have a match (as illustrated, e.g., in FIG. 3A), a gap (as illustrated in FIG. 3B) or an overlap (as illustrated in FIG. 3C) between two adjacent views if the intersection was located respectively on the boundary, outside, or inside of an imaging panel. The stitched projection images can be a union of three projection images plus the gaps between any two adjacent views. Zero intensity values for pixels can be filled in the gap region and truncated pixels in the overlap region.

The exemplary calculated gap, overlap or match between adjacent views might not be exact because the reported imaging positions may deviate from the real ones. As described herein, a “perfect stitching” description can include, but not be limited to an exact overlap or match, and can be described in other cases as “imperfect stitching.” It can be that there is no harm for “perfect stitching” since the data truncated from one imaging panel were acquired by the other panel. “Imperfect stitching”, on the other hand, may cause reconstruction artifacts, as some projection data can be lost, repeated or even not acquired. A gap (as shown in FIG. 3B) between two imaging panels can lead to missing data in the stitched view. As shown in FIG. 3D, a few columns of pixels can potentially be repeated or missing from the stitched view if the reported imaging position was different from the true one. The potential columns missing or repeating may not materialize if the same amount of positional errors happened to other imaging panels.

### Exemplary Simulation of Panoramic Projection Images Using a Digital Phantom

The Mathematical Cardiac Torso (MCAT) phantom (see, e.g., W. P. Segars, D. S. Lalush and B. M. W. Tsui, “Modeling respiratory mechanics in the MCAT and spline-based MCAT phantoms,” Nuclear Science, IEEE Transactions on 48, 89-97 (2001)), a digital anthropomorphic phantom developed for the nuclear medicine imaging research can be used to simulate the transmission projection imaging data, e.g., for a 140 keV source. Two different detector geometries can be simulated. The first can be one large imaging panel located, e.g., 150 cm from the source along the central axis. This imaging panel can consist of a matrix of 516×516 detectors with a pixel size of 1.15×1.15 mm². An exemplary 59.3×59.3 cm² panel size can be large enough to encompass the whole MCAT phantom. A total of about 360 projection images with added Poisson noise from the primary signal can be generated every degree for a 360° gantry rotation. The Siddon's ray-trace method (see, e.g., R. L. Siddon, “Fast calculation of the exact radiological path for a three-dimensional CT array,” Medical Physics 12, 252-255 (1985)) can be used to calculate the line integral through the phantom along the ray connecting the source to the detector pixel.

The second detector geometry can include three small panoramic views with two side views tilted at 30 degrees from the central position (see FIG. 2A). Different view angles can be achieved by adjusting the collimator opening. Each view can correspond to a projection image with added Poisson noise from the primary signal, acquired using an imaging panel consisting of a matrix, e.g., a matrix of 172×516 detectors with a pixel size of, e.g., 1.15×1.15 mm². The exemplary 19.8-cm panel width can be one third of the larger panel and may be not large enough to cover the whole MCAT phantom in the transverse direction. The exemplary 59.3-cm panel length for the panoramic views can be the same as that for the large imaging panel. Therefore, the first exemplary detector geometry can be the “equivalent imaging panel” for the stitched and re-binned view of the second exemplary detector geometry (sec FIG. 2B).

### Exemplary Simulation of Reconstruction Artifacts Due to Imperfect Stitching

It is also possible to simulate different types of imperfect stitching (discussed herein) that may produce reconstruction artifacts and degrade the image quality. Two exemplary experiments are described as including: (1) different amounts (e.g., 1 mm, 3 mm and 5 mm) of gap can be introduced by setting the image intensity to zero for the pixels located within half of the gap size of the intersection between two adjacent imaging panels, and (2) three consecutive-columns of pixels can be removed or repeated around the intersection between adjacent imaging panels. To investigate the effect of the exposure fluctuation, the pixel intensity of the projection images can be increased for the left view and the right view by 5% and 3%, respectively, and can be compared to the CBCT reconstruction with or without the exposure fluctuation.

The exemplary reconstruction artifacts described herein may not be introduced during the image stitching step, but can be caused by detector positions that can be improperly chosen (e.g., for gaps) or inaccurately reported (e.g., for missing or repeating columns). Therefore, these artifacts could not be removed using reconstruction procedures that do not require image stitching (e.g., algebraic reconstruction procedures), although the artifacts might appear differently for reconstructions with and without image stitching.

### Exemplary Image Reconstructions

For example, a standard SART for CBCT reconstruction can be programmed using e.g., one single large panel, or the equivalent view as shown in FIG. 2B. The SART can be modified for direct reconstruction without re-binning. In the standard SART, the correction terms can be simultaneously applied for all the rays in one projection, and the linear attenuation coefficient of each voxel can be updated after all rays passing through this voxel at one projection view can be processed; the value update of each voxel can be performed after all rays at one projection view are processed. The number of updates in one full iteration can equate to the number of projection images K, and also is called the number of subiterations. Let \hat{μ}ⱼ^{n,k} denote the estimated linear attenuation coefficient of the j-th voxel at the end of the k-th subiteration of the n-th iteration. The initial and final update values at one iteration can be assigned as follows:

\hat{μ}ⱼ^{n,1}=\hat{μ}ⱼⁿ⁻¹,\hat{μ}ⱼⁿ=\hat{μ}ⱼ^{n,k},

where \hat{μ}ⱼⁿ is the estimate at the end of the nth iteration, which is equal to the estimate after all K projection images are processed. Let G^{k}ⱼ denote the set of the measured line integrals passing through the j-th voxel at the k-th projection angle. The update of the linear attenuation coefficient at the j-th voxel can be defined as follows:

$${\hat{μ}}_{j}^{n , k + 1} = {\hat{μ}}_{j}^{n , k} + λ \frac{{Σ}_{{g}_{i} ∈ {𝒢}_{j}^{k}} ( {a}_{ij} \frac{{g}_{i} - {Σ}_{j = 1}^{M} {a}_{ij} {\hat{μ}}_{j}^{n , k}}{{Σ}_{j = 1}^{M} {a}_{ij}} )}{{Σ}_{{g}_{i} ∈ {𝒢}_{j}^{k}} {a}_{ij}}$$

where λ is a relaxation factor ranged over (0, 1], gᵢ is the line integral computed from the measured projection data at the i-th detector pixel, and aᵢⱼ the chord length of the i-th ray passing through the j-th voxel. The relaxation factor can be used to reduce the noise during reconstruction. In certain exemplary cases, this parameter can be selected as a function of the iteration number. That is, λ decreases as the number of iterations increases.

Since, in one example, there may not be filtering operations between detector readings, the application of the SART procedure is not limited to the cone beam geometry (e.g., one single large panel or the equivalent imaging panel in FIG. 2B) if the location of each individual detector can be passed to the exemplary procedure. Therefore, for the cone beam geometry, it may be possible to use the standard SART that received the pixel size and center location of the imaging panel, and calculated the location of each detector accordingly. For multiple panoramic views, e.g., this interface can be modified to receive the pixel size and center location of each imaging panel separately so that the detector location for each panel could be determined independently without re-binning. The exemplary difference between the standard SART and the exemplary modified SART can therefore be that for the modified SART, the geometry for forward and backprojections can be different for each imaging panel and can be handled separately, while the cone beam geometry can be assumed for the standard SART. Since no special weightings are needed and the forward/backprojections can be similar for imaging planes of different positions, the code change for the modified SART can be minimal.

For both standard SART and modified SART, the linear system governing the relation between the linear attenuation coefficient of each voxel and the measured line integrals can be solved iteratively, e.g., without direct matrix inversion. The reconstruction can be generated by iteratively performing projections of intermediate estimates and backprojection of correction terms. Both processing time and image quality (e.g., the contrast and the noise) can increase with the number of iterations so a compromise can be usually made considering these two factors. For example, it is possible to utilize a uniform initial guess and terminated the reconstruction after the fourth iteration. Although projection images for the full-scan acquisition were simulated, reconstructions were performed mainly for the half-scan data, which can be achieved for most treatment positions without having to shift the treatment couch to the central location to avoid collisions. The reconstruction volume can be a matrix of, e.g., 256×256×256 voxels with a voxel size of, e.g., 1 mm³. No additional corrections and image processing were used before reconstruction in this exemplary embodiment.

### Exemplary Quantitative Analysis

In one exemplary embodiment of the present disclosure, contrast-to-noise (CNR) and geometric accuracy of the reconstructed images can be calculated to evaluate the quality of reconstructed images. CNR for a simulated lung tumor in the MCAT phantom can be computed as: CNR=|S1−S2|/σ, where S1 and S2 were the average pixel values inside a region of interest and a background region, respectively, and σ was the standard deviation in the background region. Distances can also be calculated to quantify geometric distortion: one example includes the distance between the centers of two selected ribs in the coronal view and another example includes the distance between the centers of two selected ribs in the transverse view. The center location of each selected rib can be determined by measuring and averaging the coordinates (in pixels) of the right, left, top and bottom border of the rectangle encompassing the selected rib, e.g., using the cursor function in the Matlab Image Tool.

Analysis of Scattering Vs. Field Size Using Monte Carlo Simulation

Exemplary Monte Carlo simulations can also be performed with, e.g., the “egs_cbct” code (see, e.g., E. Mainegra-Hing and I. Kawrakow, “Variance reduction techniques for fast Monte Carlo CBCT scatter correction calculations,” Physics in Medicine and Biology 55, 4495 (2010); and E. Mainegra-Hing and I. Kawrakow, “Fast Monte Carlo calculation of scatter corrections for CBCT images,” Journal of Physics: Conference Series 102, 012017 (2008)) to analyze the scattering as a function of field size for an on-board imaging panel. For example, A 40 kV point source can be simulated to irradiate a 60×60×30 cm³ water phantom with one embedded bone insert of 20 cm length and 2×2 cm² cross section. The source can be placed about 100 cm upstream of the iso-center and the water phantom centered at the iso-center.

The exemplary imaging panel can be positioned 50 cm downstream of the iso-center and can be comprised of 200×200 pixels with 0.2 cm pixel pitch. The projection images can be simulated along the longest dimension of the bone insert. Therefore, the bones appeared as low-intensity rectangular regions in the projection images. Exemplary simulations can be conducted for field sizes ranging from 5×20 to 45×20 cm² defined at the iso-centric plane (or 7.5×30 to 67.5×30 cm² at the imaging plane) while the source fluence can be kept constant for all simulations. Air kerma can be scored as the detector response.

The CNR can be calculated for each simulated projection image as

$$CNR = \frac{{S}_{bone} - {S}_{water}}{{N}_{water}} CNR = ( {S}_{—} bone - {S}_{—} water ) \text{/} {(}_{—} water ,$$

where S_{bone} as the mean signal of the bone projection evaluated in the central 2.4×2.4 cm² square, S_{water} can be the mean signal of the water projection evaluated in the region of the central 6.8×6.8 cm² square minus the central 3.6×3.6 cm² square, and (_water can be the standard deviation in that region.

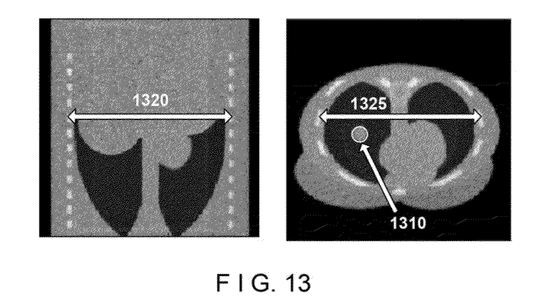

An exemplary effect of the scattering on the CBCT reconstruction for a different scanning geometry can also be demonstrated by including the scattering noise in the projection images of the MCAT phantom. Since the scattering signal is a slow varying function (see exemplary images of FIG. 13), the exemplary Monte Carlo simulation might not be performed for each projection image to reduce the computation time or alternatively may be performed for each projection. Instead, the scatter-to-primary ratio of the anterior-posterior view (e.g., 0° gantry angle) can be calculated using an exemplary Monte Carlo simulation for the big panel and for the small panel used for the 3-view panoramic CBCT, from which a constant scattering signal can be added to each projection image accordingly.

For each scanning geometry, exemplary noiseless projection data can be generated for every one degree for 200 gantry angles. The average pixel intensity of each noiseless projection image can be calculated, multiplied by the corresponding scatter-to-primary ratio, and added to each pixel. Poisson noise can then be added based on the combined (e.g., primary and scatter photons) image intensity of each pixel to obtain the exemplary noisy projection data for CBCT reconstruction. CNRs can be calculated to compare the quality of reconstructed images for one big panel and for 3-view panoramic CBCT.

### Exemplary Results

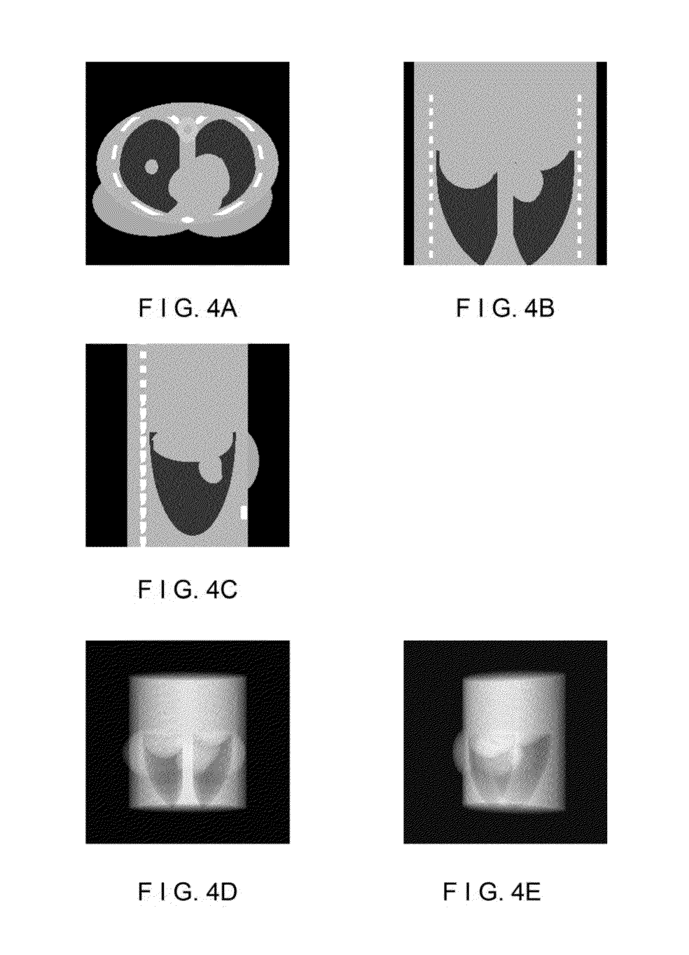

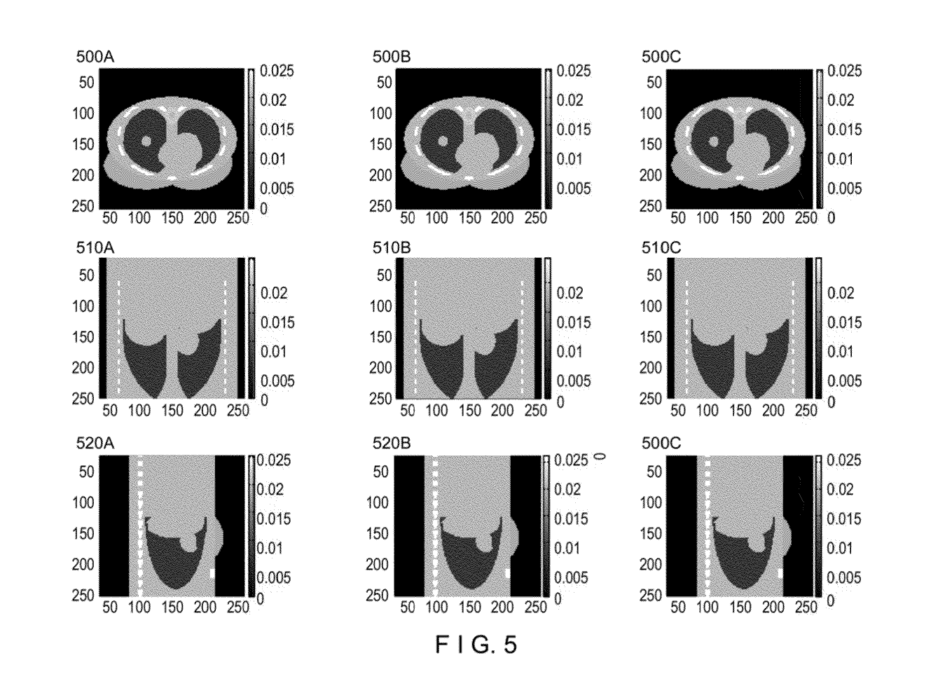

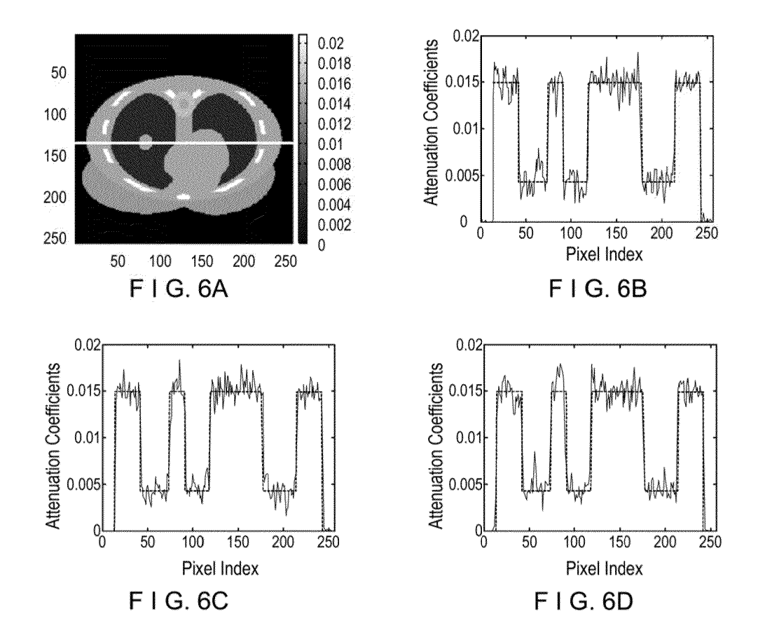

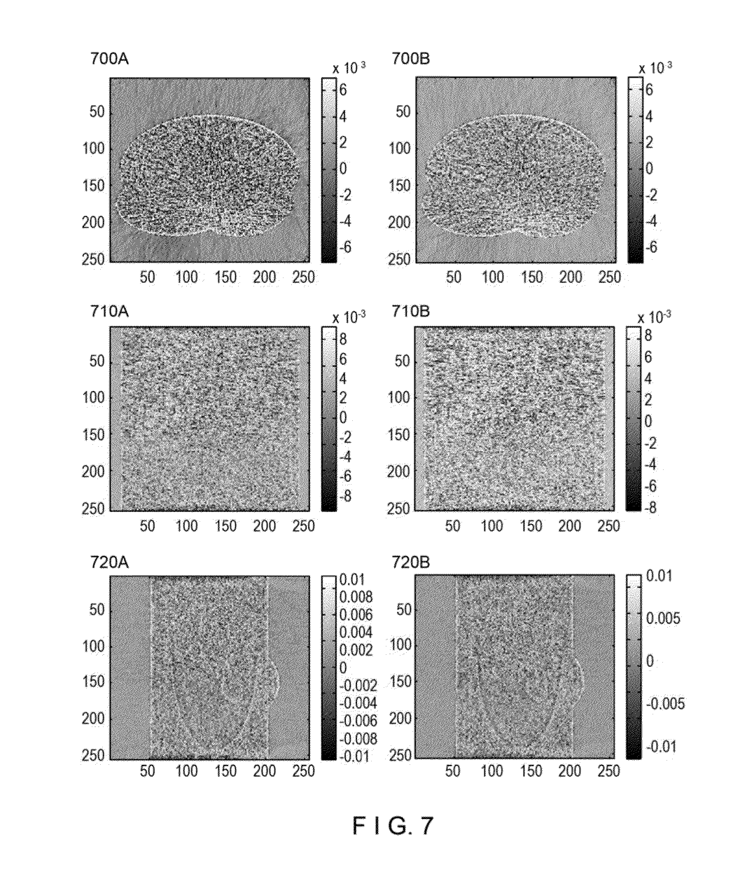

FIGS. 4A-E show exemplary transverse (see FIG. 4A), coronal (see FIG. 4B) and sagittal (see FIG. 4C) views of the exemplary MCAT phantom, as well as the equivalent projection images of the three panoramic views for gantry angles 0° (see FIG. 4D) and 45° (see FIG. 4E). FIG. 5 shows an exemplary comparison of the CBCT reconstruction from (a) 1 big panel/full scan (exemplary standard for comparison), (b) 1 big panel/half scan and (c) 3 panoramic views/half-scan, for transverse 500, coronal 510, and sagittal 520. The standard SART can be used for the CBCT reconstruction in A and B lines of FIG. 5, while a modified exemplary SART was used in the C line of FIG. 5. FIG. 6A shows an exemplary profile for comparison. FIGS. 6B-D show exemplary graphs that compare the exemplary central profiles of the transverse view between the MCAT phantom and the reconstructed images for 1 big panel/full scan (see FIG. 6B), 1 big panel/half scan (see FIG. 6C) and 3 panoramic views/half scan (see FIG. 6D) in FIG. 5. Certain exemplary good agreements (e.g., other than the noise) for all comparisons illustrated in FIGS. 6A-D can validate exemplary implementations of the standard SART and the modified SART. FIG. 7 illustrates exemplary difference images (a) between 1 big panel/full scan (of FIG. 5A) and 1 big panel/half scan (of FIG. 5B), and (b) between 1 big panel/full scans (of FIG. 5A) and 3 panoramic views/half scan (of FIG. 5C). It can be observed from FIG. 7 that the full-fan, half-scan exemplary CBCT using the standard exemplary SART and the panoramic CBCT using the modified exemplary SART can be as good as the gold standard since the differences between them were mainly noise. The A line of FIG. 7 (e.g., 700A, 710A, and 720A) illustrates difference images between 1 big panel/full scan (e.g., the A line of FIG. 5) and 1 big panel/half scan (e.g., the B line of FIG. 5). The B line of FIG. 7 (e.g., 700B, 710B, and 720B) illustrates difference images between 1 big panel/full scan (e.g., the A line of FIG. 5) and 3 panoramic views/half scan (e.g., the C line of FIG. 5).

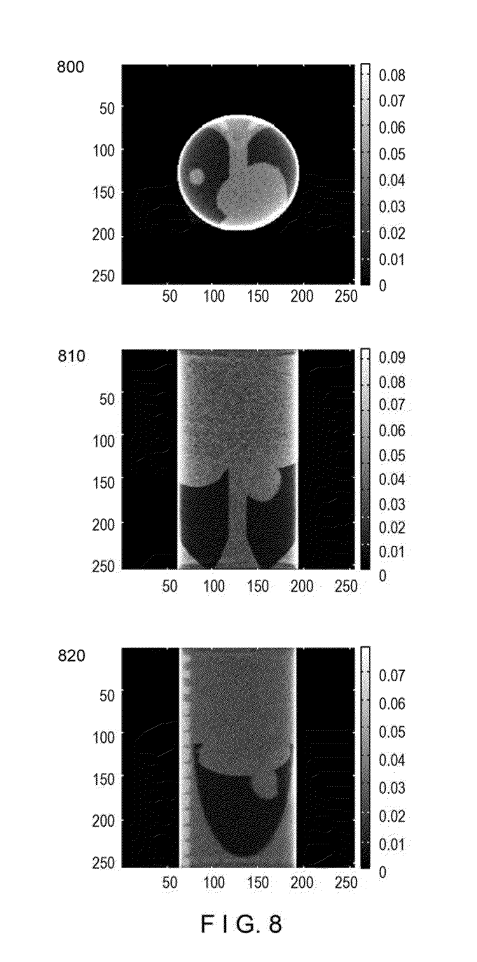

FIG. 8 shows a set of exemplary transverse 800, coronal 810 and sagittal 820 image slices of the exemplary half-scan (e.g., about 200° gantry rotation) CBCT reconstructions using the exemplary standard SART and the projection images of the central view. Artifacts can appear in both reconstructions. Image intensity near the boundary can be significantly enhanced due to the contribution of the attenuation outside the imaging volume.

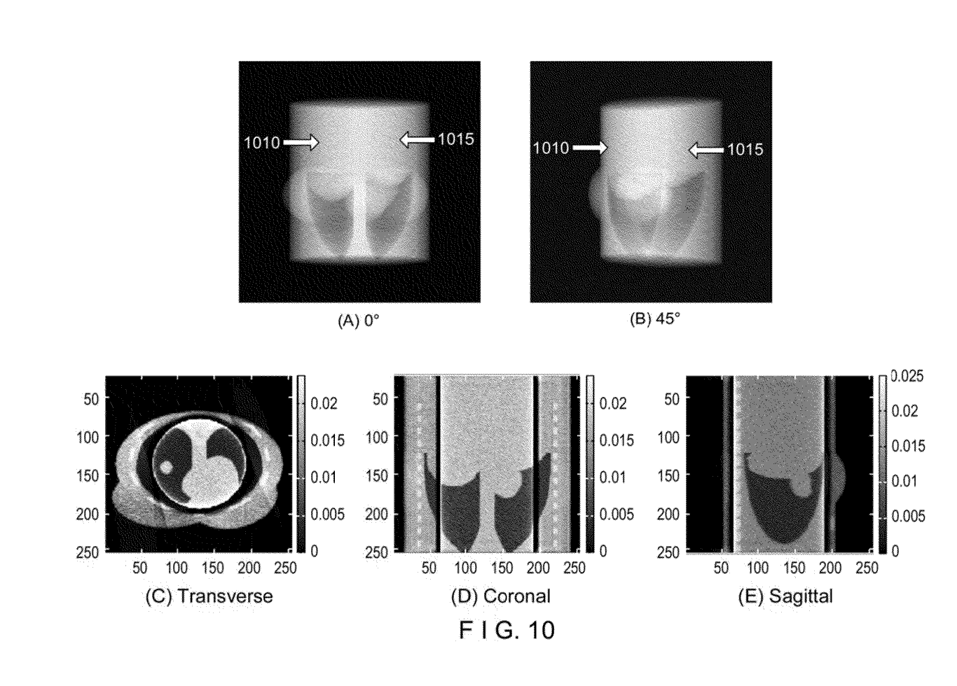

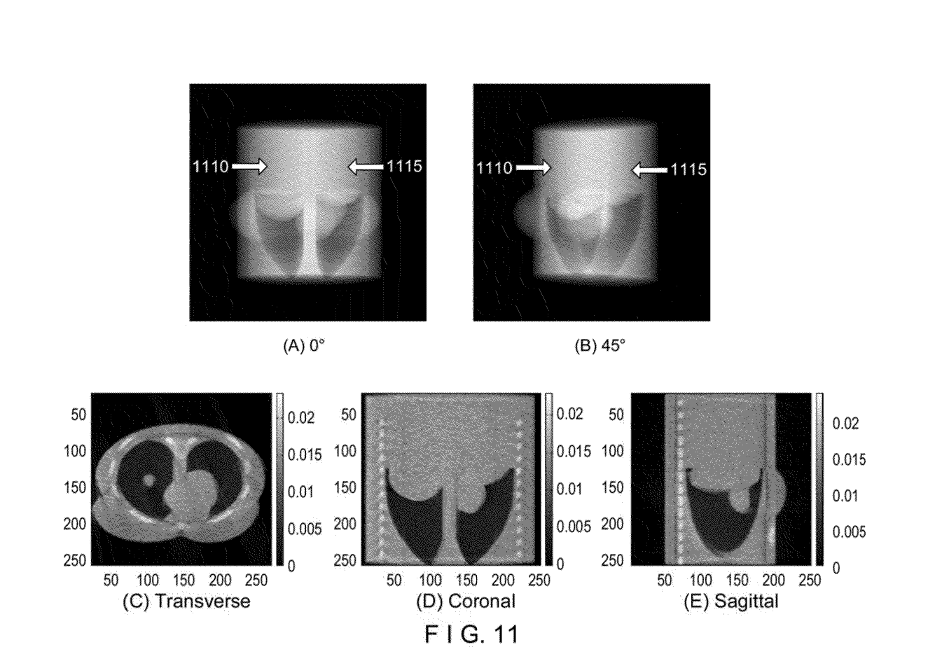

Exemplary half-scan CBCT reconstruction images using 3 panoramic views with simulated imperfect image stitching are shown in FIGS. 9-11. For example, FIG. 9 illustrates the transverse 900, coronal 910 and sagittal 920 slices of 3-view panoramic CBCT with introduced 5 mm (e.g., the A column), 3 mm (e.g., the B column) and 1 mm (e.g., the C column) gaps between adjacent views (e.g., as illustrated with arrows 1010 and 1015). Streak (transverse 900 view) and line (coronal 910 and sagittal 920 views) artifacts can be observed in all three reconstructions. FIG. 10, images A and B, illustrates exemplary equivalent projection images of the 3 panoramic views for 0° and 45° gantry angles, respectively, with 3 consecutive columns of pixels removed at the intersection between two adjacent views. An exemplary half-scan CBCT reconstruction is also illustrated for one transverse (e.g., image C), coronal (e.g., image D), and sagittal (e.g., image E) slides with observed streak (transverse view) and line (coronal and sagittal views) artifacts. FIG. 11, images A-E show similar exemplary results and artifacts with three consecutive columns of pixels repeated at the intersection between two adjacent views (e.g., as illustrated with arrows 1110 and 1115).

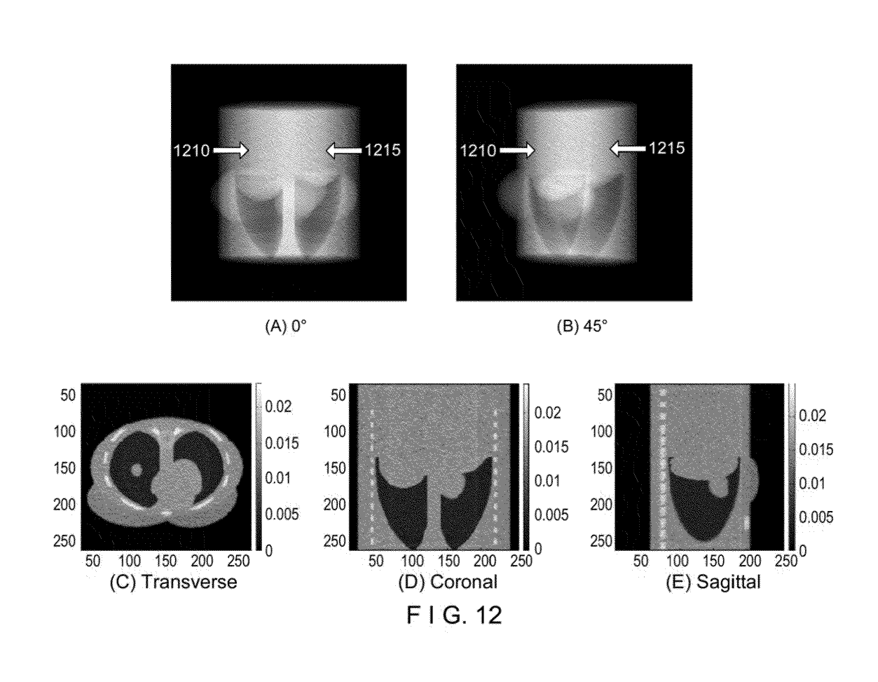

FIG. 12, images A-E, demonstrates exemplary equivalent exemplary projection images of the three panoramic views for 0° (image A) and 45° (image B) gantry angles with the image intensity of the left and right views increased by 5% and 3%, respectively, and the half-fan CBCT reconstruction for one transverse (image C), coronal (image D) and sagittal (image E) slices. Ring (transverse view) and line (coronal and sagittal views) artifacts can be observed due to the introduced exposure fluctuations. Arrows 1210 and 1215 illustrate an intersection between two views (e.g., the 0° view of image A and the 45° view of image B).

Table 1 shows the contrast-to-noise ratio CNR and geometric accuracy for the reconstructed images e.g., in FIGS. 5 and 8-12. CNR ranges from 6.4 to 11.5 for the simulated lung tumor 1310. Geometric distance 1320, 1325 between two selected ribs can also be shown for one coronal view e.g., 1320 and one transverse view e.g., 1325. Exemplary reconstructions can have the same geometric accuracy as that shown in FIG. 5, image A, except in certain exemplary embodiments, the geometric accuracy for the illustrations in FIGS. 8B, 10 and 11 can be different.

TABLE 1

| | CNR | D1 (voxels) | D2 (voxels) |
|---|---|---|---|
| Fullscan (FIG. 5A) | 11.2 | 188 | 186 |
| Half scan (1 big panel, FIG. 5B) | 11.5 | 188 | 186 |
| Half scan (3 panoramic views, FIG. 5C) | 11.0 | 188 | 186 |
| 1 mm Gap (FIG. 9C) | 11.0 | 188 | 186 |
| 3 mm (FIG. 9B) | 10.4 | 188 | 186 |
| 5 mm Gap (FIG. 9A) | 9.4 | 188 | 186 |
| Exposure fluctuations (FIG. 12) | 11.3 | 188 | 186 |
| Removed 3 columns FIG. 10) | 9.9 | 185 | 183 |
| Repeated 3 columns (FIG. 11) | 9.9 | 197 | 195 |
| Central Panel Only (FIG. 8) | 6.4 | N/A | N/A |

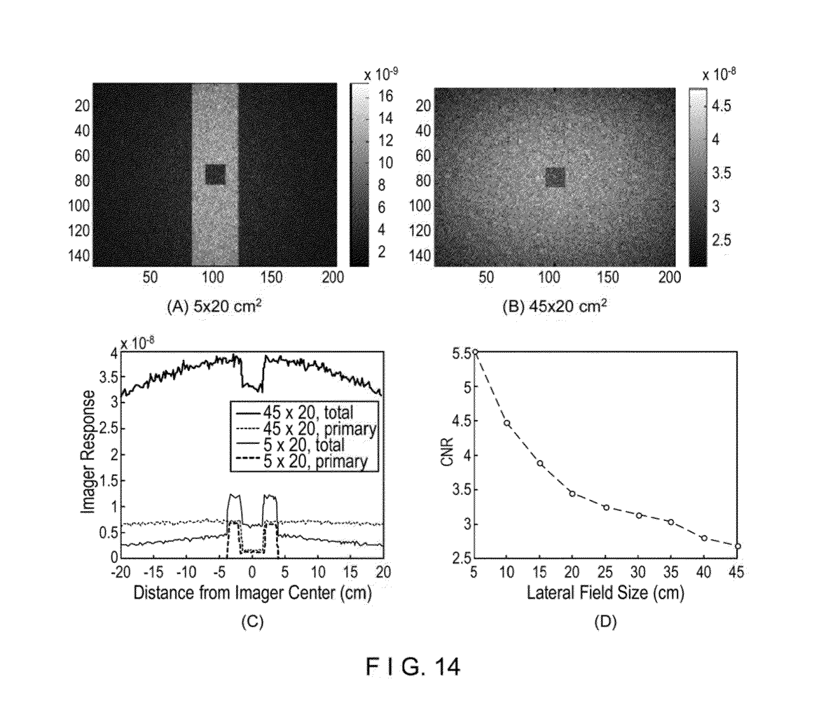

FIG. 14, images A-D, illustrates exemplary Monte Carlo simulation results for the 5×20 cm² field size (e.g., image A), the 45×20 cm² field size (e.g., image B), the central profiles of the primary signal and total (primary+scatter) signal of both fields (e.g., graph C) and the CNR versus the field size ranging from 5×20 cm² to 45×20 cm² (e.g., graph D). In general, the contrast between the central rod and the background can be similar (e.g., within 1.4%) for all field sizes but the CNR can decrease with the field size.

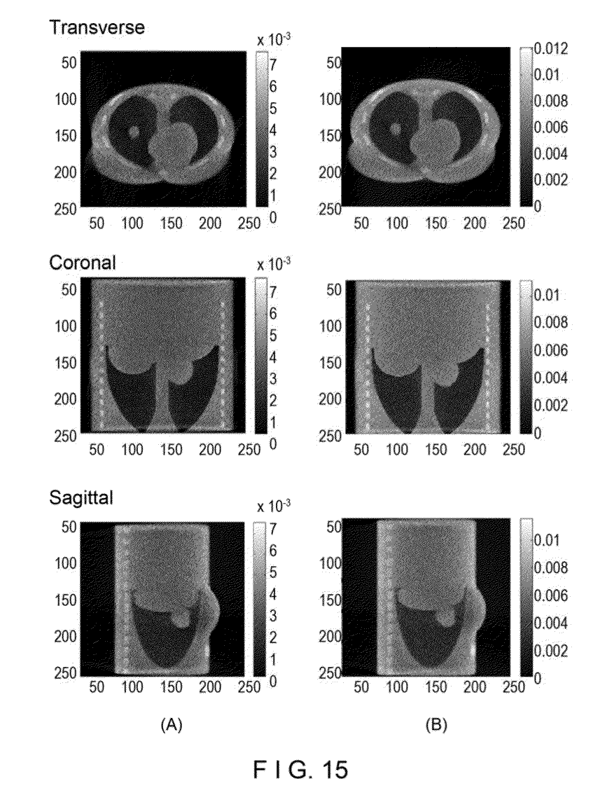

FIG. 15 shows exemplary half-scan CBCT reconstructions using exemplary projection images of one big panel (e.g., the A column of images) and three panoramic views with added Poisson noise from both primary and scatter signals (e.g., the B column of images). The scatter-to-primary ratios used to determine the amount of added Poisson noise were 0.99 (e.g., in FIG. 15, A images) and 0.58 (e.g. in FIG. 15, B images), calculated using the Monte Carlo simulations. The CNR was 4.1 (e.g., in FIG. 15, A images) and 6.25 (e.g., shown in FIG. 15, B images) in comparison to 11.5 (see, e.g., FIG. 5, B images) and 11.0 (see, e.g., FIG. 5, C images), respectively, when Poisson noise from the scattering event was not included in those exemplary embodiments.

### Details and Discussion of Exemplary Embodiments

It is possible that the full-fan, half-scan CBCT using the FDK algorithm suffers more severe cone-beam artifacts than the full-fan, full-scan CBCT for slices away from the central slice due to increased missing data. (See, e.g., K. Taguchi, “Temporal resolution and the evaluation of candidate algorithms for four-dimensional CT,” Medical Physics 30, 640-650 (2003)) This phenomenon (e.g., reduced image quality for the half-scan CBCT), however, may not be observed. As shown in FIGS. 5A-5C and indicated in Table 1, exemplary CBCT reconstructions can be virtually identical for 1 big panel/full scan (see, e.g., FIG. 5A) and 1 big panel/half (see, e.g., FIG. 5B) and the image quality is similar, which can be due to the use of the SART instead of the FDK algorithm for reconstruction. These exemplary results are also consistent with the earlier report by Maaβ et al. who demonstrated that the SART has less cone-beam artifacts than the FDK algorithm. (See, e.g., C. Maaβ, F. Dennerlein, F. Noo and M. Kachelrieβ, presented at the Nuclear Science Symposium Conference Record (NSS/MIC), 2010 IEEE, 2010 (unpublished)).

Exemplary half-scan panoramic CBCT can produce virtually equivalent image quality as the full-fan, full-scan CBCT using one large imaging panel (see, e.g., FIG. 5 and Table 1), which can have significant clinical implications. First, since the half scan can be performed for most tumor locations and patient sizes without a gantry collision with the couch, patients with peripheral lesions can be imaged at the treatment position instead of being shifted to the central couch position to avoid collisions. Secondly, because the reconstruction volume of the exemplary panoramic CBCT can be as large as practically needed, the reconstruction artifacts due to truncation can be eliminated, leading to more accurate CT numbers. Finally, the accuracy of IGRT can improve with the panoramic CBCT as a larger imaging volume can encompass more anatomic landmarks/critical organs to provide more accurate anatomic information for image guidance.

Exemplary results shown in FIGS. 5-7 also demonstrate that the modified SART can be as effective as the standard SART for CBCT reconstruction. The modified SART can be the standard SART except that can directly process the projection data of each view for reconstruction. Data re-binning can be used for reconstruction using the standard SART for cone beam geometry. Although such operation can be mathematically simple, it can pose a challenge for digital images as real image data may not exist between pixels and complex image processing may be required to interpolate the existing image data. Imperfect re-binning can also result in blurred images and can degrade the geometric accuracy. The exemplary modified SART can reduce or eliminate these reconstruction artifacts and can save the time for re-binning.

As shown in FIGS. 9-11 and provided in Table 1, imperfect image stitching can be a significant source of reconstruction artifacts for the panoramic CBCT, which can lead to degraded CNR and/or geometric distortion. A gap between adjacent views can occur when the projection images are not properly captured at the edge of the imaging panel or when there are no detectors at the intersection between two adjacent views. Although the existence of gaps between adjacent views generally does not affect the geometric accuracy (see, e.g., Table 1), it can produce streak and line artifacts (see FIG. 9) and can degrade CNR with increasing gap size (see Table 1). These artifacts can be avoided by overlapping the imaging areas of adjacent views so that image intensity around the intersection can be properly interpolated.

Columns missing or repeating might occur in direct image stitching when the reported imaging position differs from the exact one due to sagging. As shown in, e.g., FIGS. 10-11 and provided in Table 1, in addition to streak and line artifacts, this type of imperfect stitching can also degrade CNR and introduces geometric distortions. Columns missing or repeating can be corrected using, e.g., a lookup table if the sagging of the imaging panel is reproducible. Alternatively or additionally, software correction can be used. For example, it is possible to utilize exemplary image stitching algorithms already developed in computer vision for panoramic photography, which can use rotational motion modeling and feature-based methods to calculate the overlap between a pair of images. Exemplary procedures can also be provided to correct the ring and line artifacts due to exposure fluctuations (see, e.g., FIG. 12). It is possible to provide the exposure fluctuations with a dynamic programming formulation, or more robustly using the Markov random field (MRF) approach.

With the large stitched projection data set, there may be a limitation of the computational burden of the iterative nature of SART reconstruction procedure. The use of CBCT for image-guided radiotherapy can utilize an exemplary real-time reconstruction so that prior to the radiation treatment, patient positioning can be verified by comparing daily CBCT with the reference CT from treatment planning and simulation. However, a typical SART reconstruction for the exemplary test cases in this review can take about 8 hours to complete using the conventional single-thread CPU-based processing arrangement. Since the exemplary CBCT reconstruction procedures can generally involve multiple forward projections of the intermediate estimates and back-projections of the projection image data, most of the time-consuming part of SART reconstruction can be processed in parallel. It is possible, according to one exemplary embodiment, to utilize the acceleration of the modified SART using OpenCL (Open Computing Language) and general-purpose graphics processing unit (GPU) board. One exemplary test can indicate that the exemplary GPU implementation of the forward-projection operation is about 100 times faster than the exemplary CPU implementation. It is also possible to improve the reconstruction speed by enhancing the exemplary procedure to exhibit data locality so that the reconstruction speed can be comparable to that of the current CBCT in clinical use.

By visual inspection of exemplary images shown in FIG. 13, the exemplary projection image for the 45×20 cm² field size is noisier than that for the 5×20 cm² field size. This difference can be explained by the primary signals of both profiles in FIG. 13C being comparable but the total signal of the 45×20 cm² field being much larger than that of the 5×20 cm² field, which can indicate a much higher scattering signal for the 45×20 cm² field. Since the scattering signal only increases the noise but contrast, the CNR can therefore be lower for the 45×20 cm² field. The same explanation can apply to the results shown in FIG. 13D that the CNR decreases with the field size. Since the same number of photons can be used in the Monte Carlo simulation for each field size, results shown in FIG. 13D can indicate that for the same mAs, the image quality can be better for the smaller field size. Better image quality for projection images can also lead to a better image quality for CBCT reconstruction of the MCAT phantom. As shown in FIG. 14, for the same imaging volume and dose, there can be about 50% improvement when using 3 panoramic views (CNR=6.25) over using one big panel (CNR=4.1). Therefore, the image quality of the panoramic CBCT can be better than that acquired with an equivalent imaging panel for the same imaging volume and same mAs. On the other hand, if the same image quality is used, the panoramic CBCT can have a lower mAs than using the equivalent imaging panel.

In addition to image quality, imaging dose and imaging time can be two other exemplary concerns for IGRT using CBCT. For the same mAs, the imaging dose of panoramic CBCT may be the same as using the equivalent imaging panel, assuming the leakage dose is negligible and there are no overlaps between the adjacent views. As discussed herein, an exemplary overlap between adjacent views may be needed to minimize the artifacts due to discontinuity or a gap around the intersection. Assuming the percent increase in the imaging dose is the fraction of imaging width overlapped with the adjacent imaging panel, a 2-view panoramic CBCT with an imaging width of 20 cm and an overlap of 0.5 cm increases the imaging dose by ˜5% (2×0.5/20). As shown in FIG. 13D, the CNR for 20×20 cm² is ˜3.4 while the CNR for a 40×20 cm² is ˜2.8, possibly indicating that the 2-view panoramic CBCT can achieve the same image quality with ˜32% less mAs or a reduction of the imaging dose by ˜32%. Therefore, an increased imaging dose due to overlap can be offset by the gain in image quality.

The exemplary leakage limitation for a kV x-ray source can be 1 mGy/h (or 0.017 mGy/min) at 1 m from the source. The sources can operate in pulsed mode at, e.g., 100 to 125 kV and up to, e.g., 90 mA and 25 ms per pulse depending on the anatomical position of the treatment site. Therefore, most CBCT scans can be acquired with a beam-on-time on the order of about 15 seconds (assuming about 600 projections and 25 ms/projection) or less and the leakage dose can then be less than about 0.1% of the imaging dose (e.g., on the order of about 10-20 mGy per scan) of a typical CBCT scan. The additional leakage dose due to the panoramic CBCT can therefore be low or negligible since in most cases 3-view panoramic CBCT can be clinically sufficient, which can increase the imaging dose by no more than 0.2%. Consequently, for the same image quality, the imaging dose of panoramic CBCT can be lower than the standard CBCT using an equivalent imaging panel for the same imaging volume.

In comparison to the standard half-fan, the exemplary full-scan CBCT, a 2-view panoramic CBCT may pay a slight price in imaging dose (e.g., ˜11% higher, 400° vs. 360° rotation assuming the same overlap) to avoid a collision. A 3-view CBCT can provide an additional imaging dose to the region outside the imaging volume of the standard CBCT, which can be irradiated although not imaged, not necessarily to save the imaging dose but can be due to the limited size of the imaging panel. The additional dose for panoramic CBCT can be used to fulfill what is intended but not achieved by the half-fan, full-scan CBCT.

Although the exemplary panoramic CBCT can have a better image quality and comparable imaging dose, its use may not be justified unless the imaging time is similar to or less than that of standard CBCT. Since the panoramic CBCT can use at least two repeated half rotations, it might not replace the full-fan, half-scan CBCT for small targets as well as the half-fan, full-scan CBCT for larger targets that doe not cause collisions. However, the panoramic CBCT can have an advantage in scanning time over the standard CBCT for peripheral lesions that require couch shift so that the half-fan, full scan CBCT can be performed without collision. Assuming one full scan takes about a minute, two exemplary half scans (e.g., about 4000 rotation) can take about an additional 7 seconds for image acquisition than one full scan (about 360° rotation). However, the half-fan, full scan CBCT can use additional 20-30 seconds to rotate the gantry to the starting position (e.g., at 1800) than the panoramic CBCT (e.g., starting between about 270° and 90°). The half-fan, full scan CBCT can utilize additional time to shift the couch to the central position before imaging (to avoid a collision) and back to the treatment position after the CBCT acquisition. The additional time for couch shift might take a few minutes if done manually, and can be reduced to less than a half minute if performed automatically. An automatic couch movement on the order of 5 cm or more within a short time may cause some patient discomfort. Acceleration and deceleration of the couch movement might also produce unexpected patient motions that are difficult to detect. As a result, in either (manual or automatic movement) case, additional QA can be used after CBCT acquisition to confirm that the couch and patient are returned to the original position so that the corrections from the CBCT can be properly applied. Most or all such additional uncertainties and QA can be eliminated with the panoramic CBCT that can image the patient at the treatment position, in accordance with exemplary embodiments of the present disclosure.

The exemplary panoramic CBCT can be a better option if the target is too large to be fully covered by the half-fan, full-scan CBCT. Although truncated images can still be useful, important anatomic features may be lost or be compromised by reconstruction artifacts. With the exemplary panoramic CBCT, according to certain exemplary embodiment of the present disclosure, it can be possible to acquire the tomographic images of the whole target in the transverse direction, which can contain more accurate anatomic information for image guidance and possibly for real-time re-planning.

Thus, exemplary embodiments of the panoramic CBCT technique, according to the present disclosure, can be used to complement the half-fan, full-scan CBCT and improve the efficiency and image quality of CBCT for certain IGRT applications. The exemplary panoramic CBCT techniques can significantly increase the imaging volumes by, e.g., stitching together the projection images of multiple half scans, each with a different view angle. Since the half scan can be achieved for most treatment positions without couch collisions, the exemplary panoramic CBCT can be used image tumors at any location for a patient of any size at the treatment position without having to move the patient to the central location. The capability to include the whole patient anatomy in the scan also facilitates a the real-time dose calculation and re-planning. The exemplary panoramic CBCT can also have less scattering noise and therefore better image quality than the half-fan, full-scan CBCT. However, the image quality of panoramic CBCT may be compromised by imperfect image stitching that is difficult to detect and correct with the exemplary direct image stitching method, system and computer-accessible medium. Thus, exemplary image stitching c to improve the accuracy of image stitching.

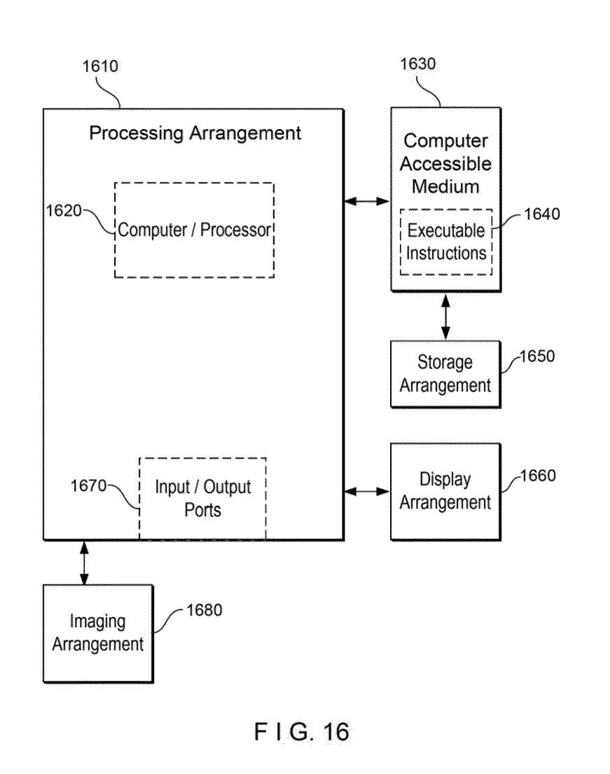

FIG. 16 shows a block diagram of an exemplary embodiment of a system according to the present disclosure. For example, exemplary procedures in accordance with the present disclosure described herein can be performed by a processing arrangement and/or a computing arrangement 1610 and a imaging arrangement 1680. Such processing/computing arrangement 1610 can be, e.g., entirely or a part of, or include, but not limited to, a computer/processor 1620 that can include, e.g., one or more microprocessors, and use instructions stored on a computer-accessible medium (e.g., RAM, ROM, hard drive, or other storage device).

As shown in FIG. 16, e.g., a computer-accessible medium 1630 (e.g., as described herein above, a storage device such as a hard disk, floppy disk, memory stick, CD-ROM, RAM, ROM, etc., or a collection thereof) can be provided (e.g., in communication with the processing arrangement 1610). The computer-accessible medium 1630 can contain executable instructions 1640 thereon. In addition or alternatively, a storage arrangement 1650 can be provided separately from the computer-accessible medium 1630, which can provide the instructions to the processing arrangement 1610 so as to configure the processing arrangement to execute certain exemplary procedures, processes and methods, as described herein above, for example.

Further, the exemplary processing arrangement 1610 can be provided with or include an input/output arrangement 1670, which can include, e.g., a wired network, a wireless network, the internet, an intranet, a data collection probe, a sensor, etc. As shown in FIG. 16, the exemplary processing arrangement 1610 can be in communication with an exemplary display arrangement 1660, which, according to certain exemplary embodiments of the present disclosure, can be a touch-screen configured for inputting information to the processing arrangement in addition to outputting information from the processing arrangement, for example. Further, the exemplary display 1660 and/or a storage arrangement 1650 can be used to display and/or store data in a user-accessible format and/or user-readable format.

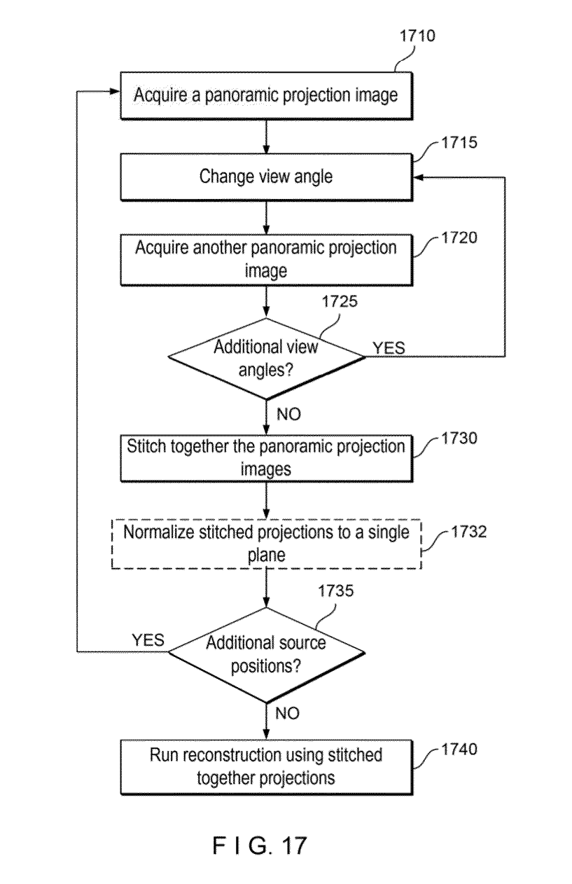

FIG. 17 illustrates and exemplary procedure, according to an exemplary embodiment of the present disclosure. The exemplary procedure can be used to acquire a plurality of panoramic projection images for each of a plurality of source locations, stitch each set of panoramic projection images into a larger image and contract a resulting image from those larger images (e.g., one per source location). For example, at 1710, the exemplary procedure can acquire a panoramic projection image, change the view angle at 1715 (e.g., by adjusting the source angle or adjusting a collimator angle), and acquire at least one other panoramic projection image at 1720. If additional panoramic projection images are needed for a particular source location, the exemplary procedure can repeat 1715 and 1720 via 1725. Otherwise, the exemplary procedure can move forward to stitch together the two or more projection images. These images can be at two or more angles to each other (e.g., as illustrated in FIG. 2A), and at 1732, certain exemplary embodiments can optionally flatten those images to a single plane (e.g., the plane normal or perpendicular to the source point) (e.g., as illustrated in FIG. 2B). This exemplary procedure can be repeated via 1735 for a plurality of source positions. Once all of the source positions have an associated stitched together image, the exemplary procedure can reconstruct a resulting image, using the stitched together images. Certain exemplary embodiments can do this with traditional methods (e.g., methods designed to take in a single projection image per source point, which is herein approximated by the exemplary embodiments stitched together set of multiple projection sub-images). Certain exemplary embodiments can do the reconstructing with the raw panoramic projections (e.g., in an exemplary embodiment that may not perform the initial construction of approximate projection images from the panoramic images, but rather perform a resulting reconstruction from total set of panoramic images, e.g., with associated data about source position and angle of imaging).

The foregoing merely illustrates the principles of the disclosure. Various modifications and alterations to the described embodiments will be apparent to those skilled in the art in view of the teachings herein, and especially in the appended numbered paragraphs. It will thus be appreciated that those skilled in the art will be able to devise numerous systems, arrangements, and methods which, although not explicitly shown or described herein, embody the principles of the disclosure and are thus within the spirit and scope of the disclosure. In addition, all publications and references referred to above are incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement which can be a microprocessor, mini, macro, mainframe, etc. In addition, to the extent that the prior art knowledge has not been explicitly incorporated by reference herein above, it is explicitly being incorporated herein in its entirety. All publications referenced above are incorporated herein by reference in their entireties.

What is claimed is:

1. A method for providing at least one particular projection image associated with at least one target, comprising:
at a plurality of locations of at least one source arrangement:
acquiring a plurality of panoramic projection images associated with at least one target, at least two of the panoramic projection images being obtained at view angles which are different from one another;
stitching or combining the panoramic projection images together; and
generating the at least one particular projection image using a computed tomography procedure based on the stitched or combined projection images that are generated at the plurality of location.

2. The method of claim 1, wherein the acquisition of the panoramic projection images comprises:
scanning the at least one target with the at least one source arrangement that is aimed at different view angles with a field size comparable to a size of an imaging arrangement which performs the acquisition, and
repositioning the stitched projection images according to the different view angles.

3. The method of claim 2, wherein the source arrangement is aimed at the different view angles by at least one of physically rotating the source arrangement or implementing different collimator settings.

4. The method of claim 2, wherein the imaging arrangement is configured to be positioned in any location along a path of a beam generated by the at least one source arrangement.

5. The method of claim 1, wherein the stitching or combining of the panoramic projection images includes:
for each of the view angles, interpolating certain ones of the panoramic projection images of neighboring gantry angles to generate further ones of the panoramic projection images at the neighboring gantry angles,
directly stitching or combining of the further ones of the panoramic projection images of the neighboring gantry angle according to a position of the imaging arrangement, and
automatically stitching or combining the further ones of the panoramic projection images of the neighboring gantry angles together.

6. The method of claim 1, wherein the computed tomography is performed by at least one of:
projecting the stitched or combine projection images into at least one plane that is perpendicular to a central axis of the at least one source arrangement; and
reconstructing tomographic images from the stitched or combined projection images without an additional projection to the at least one plane.

7. The method of claim 1, wherein the computed tomography at least one of:
a. includes a reconstruction volume that is proportional to a number of panoramic views of the at least one target; and
b. is achieved with the projection images obtained from an approximate half gantry rotation of the at least one source arrangement.

8. The method of claim 7, wherein the approximate half gantry rotation is one half of (180 degrees plus a cone angle of the at least one source arrangement).

9. The method according to claim 1, wherein the computed tomography procedure is a panoramic cone beam computed tomography (CBCT) procedure.

10. A non-transitory computer-accessible medium having stored thereon computer executable instructions for providing at least one particular projection image associated with at least one target, when the executable instruction are executed by a processing arrangement, configure the processing arrangement to perform a procedure comprising:
at a plurality of locations of at least one source arrangement:
acquiring a plurality of panoramic projection images associated with at least one target, at least two of the panoramic projection images being obtained at view angles which are different from one another;
stitching or combining the panoramic projection images together; and
generating the at least one particular projection image using a computed tomography procedure based on the stitched or combined projection images that are generated at the plurality of location.

11. The computer-accessible medium of claim 10, wherein the acquisition of the panoramic projection images comprises:
scanning the at least one target with the at least one source arrangement that is aimed at different view angles with a field size comparable to a size of an imaging arrangement which performs the acquisition, and
repositioning the stitched projection images according to the different view angles.

12. The computer-accessible medium of claim 11, wherein the source arrangement is aimed at the different view angles by at least one of physically rotating the source arrangement or implementing different collimator settings.

13. The computer-accessible medium of claim 11, wherein the imaging arrangement is configured to be positioned in any location along a path of a beam generated by the at least one source arrangement.

14. The computer-accessible medium of claim 10, wherein the stitching or combining of the panoramic projection images includes:
for each of the view angles, interpolating certain ones of the panoramic projection images of neighboring gantry angles to generate further ones of the panoramic projection images at the neighboring gantry angles,
directly stitching or combining of the further ones of the panoramic projection images of the neighboring gantry angle according to a position of the imaging arrangement, and
automatically stitching or combining the further ones of the panoramic projection images of the neighboring gantry angles together.

15. The computer-accessible medium of claim 10, wherein the computed tomography is performed by at least one of:
projecting the stitched or combine projection images into at least one plane that is perpendicular to a central axis of the at least one source arrangement; and
reconstructing tomographic images from the stitched or combined projection images without an additional projection to the at least one plane.

16. The computer-accessible medium of claim 10, wherein the computed tomography at least one of:
a. includes a reconstruction volume that is proportional to a number of panoramic views of the at least one target; and
b. is achieved with the projection images obtained from an approximate half gantry rotation of the at least one source arrangement.

17. The computer-accessible medium of claim 16, wherein the approximate half gantry rotation is one half of (180 degrees plus a cone angle of the at least one source arrangement).

18. The computer-accessible medium according to claim 10, wherein the computed tomography procedure is a panoramic cone beam computed tomography (CBCT) procedure.

19. A system for providing at least one particular projection image associated with at least one target, comprising:
a processing arrangement configured to perform a procedure comprising:
at a plurality of locations of at least one source arrangement:
acquiring a plurality of panoramic projection images associated with at least one target, at least two of the panoramic projection images being obtained at view angles which are different from one another;
stitching or combining the panoramic projection images together; and
generating the at least one particular projection image using a computed tomography procedure based on the stitched or combined projection images that are generated at the plurality of location.

20. The system of claim 19, wherein the acquisition of the panoramic projection images comprises:
scanning the at least one target with the at least one source arrangement that is aimed at different view angles with a field size comparable to a size of an imaging arrangement which performs the acquisition, and
repositioning the stitched projection images according to the different view angles.

21. The system of claim 20, wherein the source arrangement is aimed at the different view angles by at least one of physically rotating the source arrangement or implementing different collimator settings.

22. The system of claim 20, wherein the imaging arrangement is configured to be positioned in any location along a path of a beam generated by the at least one source arrangement.

23. The system of claim 19, wherein the stitching or combining of the panoramic projection images includes:
for each of the view angles, interpolating certain ones of the panoramic projection images of neighboring gantry angles to generate further ones of the panoramic projection images at the neighboring gantry angles,
directly stitching or combining of the further ones of the panoramic projection images of the neighboring gantry angle according to a position of the imaging arrangement, and
automatically stitching or combining the further ones of the panoramic projection images of the neighboring gantry angles together.

24. The system of claim 19, wherein the computed tomography is performed by at least one of:
projecting the stitched or combine projection images into at least one plane that is perpendicular to a central axis of the at least one source arrangement; and
reconstructing tomographic images from the stitched or combined projection images without an additional projection to the at least one plane.

25. The system of claim 19, wherein the computed tomography at least one of:
a. includes a reconstruction volume that is proportional to a number of panoramic views of the at least one target; and
b. is achieved with the projection images obtained from an approximate half gantry rotation of the at least one source arrangement.

26. The system of claim 25, wherein the approximate half gantry rotation is one half of (180 degrees plus a cone angle of the at least one source arrangement).

27. The system according to claim 19, wherein the computed tomography procedure is a panoramic cone beam computed tomography (CBCT) procedure.
